(19) United States
(12) Patent Application Publication
(10) Pub. No.: US 2006/0199565 A1
(43) Pub. Date: Sep. 7, 2006

(54) Enhancement to the IEEE 802.11 protocol handshake

(75) Inventor: Sergio Ammirata, Coral Springs, FL (US)

Correspondence Address: RUBEN ALCOBA, ESQ., 3399 NE 72 AVENUE, SUITE211, MIAMI, FL, 33122, US

(73) Assignee: Wialan Technology A Florida Corporation

(21) Appl. No.: 11/073,450

(22) Filed: Mar. 7, 2005

(51) Int. Cl. H04M 3/16

(52) U.S. Cl. 455/411

(57) ABSTRACT

A method of enhancing the 802.11 IEEE standard handshake protocol so that the range of connectivity between a first wireless device and other wireless devices can be extended.

### BACKGROUND

In a wireless network environment, it is essential to transmit the strongest possible signal, thereby increasing the range between access points and devices. The 802.11 IEEE standard protocol is one of the preferred methods of transmitting wireless Ethernet transmissions. The typical method of transmitting a handshake between devices is to have a three step authentication and a three step association handshake. Although this is a method of establishing a link between wireless devices, the process limits the distance of connectivity between the devices.

If the authentication and/or the association were not to limit the connectivity between devices, the devices would be able to transfer data at further distances. At the current time, devices using the above 802.11 standard are limited to a range of connectivity controlled by the handshake instead of determined by the power output of the radio and the sensitivity of the receiver.

The inventor realizing that the limitations of connectivity are resolved by eliminating steps in the handshake. The reason for this is that at greater distances the timing for the protocol exchange between the devices becomes longer than the timeouts permitted.

### SUMMARY

The present invention is directed to a method that enhances the range of connectivity between two wireless devices using a derivation of the 802.11 IEEE standard handshake protocol. A method of enhancing the 802.11 IEEE standard handshake protocol so that the range of connectivity between a first wireless device and other wireless devices can be extended, which comprises the steps of first sending a beacon from the first wireless device, then receiving from any other wireless device an authentication request, then sending an authentication response to the other wireless device, then receiving an association request from the other wireless device, and lastly sending an association response to the other wireless device.

A wireless device that can accept connections from other wireless devices will broadcast its presence using a beacon. In the above method, the first step that the first wireless device performs is to send a beacon to any other device using the same 802.11 IEEE standard protocol. The beacon is a general broadcast to the wireless environment. The second step in the above method consists of another wireless device that chooses to communicate with the first wireless device transmitting an authentication request to the first wireless device. After receiving the authentication request, the first wireless device verifies the identity of the transmitting device against its internal database of allowed devices. If the other wireless device is authorized then the first wireless device sends an affirmative authentication response. After the other wireless device receives the authentication response, the other wireless device transmits an association request to the first wireless device. Lastly, the first wireless device checks the identity of the other device trying to associate against a database of authenticated devices. The first wireless device finds that the other device is authenticated, then it sends an affirmative association response.

In another variation of this invention, after the first wireless device sends the authentication response to the other wireless device, the other wireless device sends an authentication acknowledgment to the first wireless device. The reason for sending the authentication acknowledgment is to verify that the other device received the affirmative authentication response.

In yet another variation of the current invention, after sending the association response to the other wireless device, the method further comprises receiving an association acknowledgment from the other wireless device. This variation is similar to standard 802.11 IEEE standard handshake. However, here the present invention eliminates the authentication acknowledgment requirement. By eliminating the authentication acknowledgment requirement the overall time to complete the authentication step is reduced.

An objective of this invention is to increase the range in which two wireless devices can establish a link.

Another objective of this invention is to increase the probability that a handshake will be completed under weak wireless signal conditions.

Yet a further objective of this invention is to reduced the overall time that it takes to complete the authentication step.

A further objective of this invention is to reduce the overall time that it takes to complete the association step.

Another objective of this invention is to allow users of the 802.11 IEEE standard handshake protocol to connect to a first wireless device using the method of this invention.

Other embodiments of the present invention and advantages of the present invention are described below.

### DRAWINGS

A brief understanding of the present invention can be obtained when the following detailed description of an exemplary embodiment is considered in conjunction with the following drawings, in which:

FIG. 1 illustrates a flowchart of this invention that has eliminated two steps of the 802.11 IEEE standard handshake;

FIG. 2 illustrates another embodiment of the 802.11 IEEE handshake that has eliminated one step of the 802.11 IEEE standard handshake;

FIG. 3 illustrates yet another embodiment of the 802.11 IEEE handshake that has eliminated a step of the 802.11 IEEE standard handshake; and

FIG. 4 illustrates flowchart of the 802.11 IEEE handshake, the prior art, with all of its steps.

### DESCRIPTION

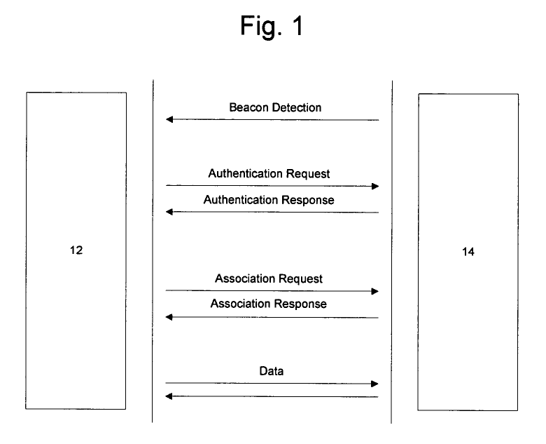

As seen in FIG. 1, a method of enhancing the 802.11 IEEE standard handshake protocol so that the range of connectivity between a first wireless device 14 and other wireless devices 12 can be extended, which comprises the steps of sending from the first wireless device 14 a beacon, then receiving from any other wireless device 12 an authentication request, then sending an authentication response to the other wireless device 12, then receiving an association request from the other wireless device 12, and lastly sending an association response to the other wireless device 12. After the above steps are completed the transfer of data between devices commences.

The first wireless device 14 is able to accept wireless connections from other wireless devices and will broadcast its presence to third party devices using a beacon. In the above method, the first step that the first wireless device 14 performs is to send a beacon to any other device 12 using the same 802.11 IEEE standard protocol. The beacon is a general broadcast to the wireless environment. The second step in the above method consists of another wireless device 12 that chooses to communicate with the first wireless device 14 transmitting an authentication request to the first wireless device 14. After receiving the authentication request, the first wireless device 14 verifies the identity of the transmitting/other device 12 against its internal database of allowed devices, and if the other wireless device 12 is authorized, then the first wireless device sends an affirmative authentication response. Then, after the other wireless device 12 receives the authentication response, the other wireless device 12 transmits an association request to the first wireless device 14. Lastly, the first wireless device 14 then checks the identity of the other device 12 that is trying to associate against its database of authenticated devices and if it finds that the other device 12 is authenticated it then sends an affirmative association response.

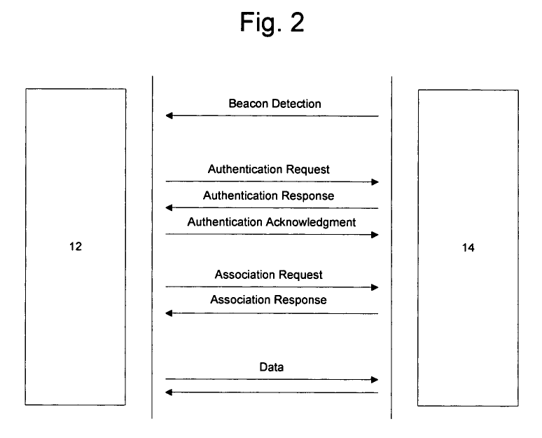

As seen in FIG. 2, in another embodiment of this invention, after the first wireless device 14 sends the authentication response to the other wireless device 12, the other wireless device 12 sends an authentication acknowledgment to the first wireless device 14. The reason for sending the authentication acknowledgment is to verify that the other device 12 received the affirmative authentication response.

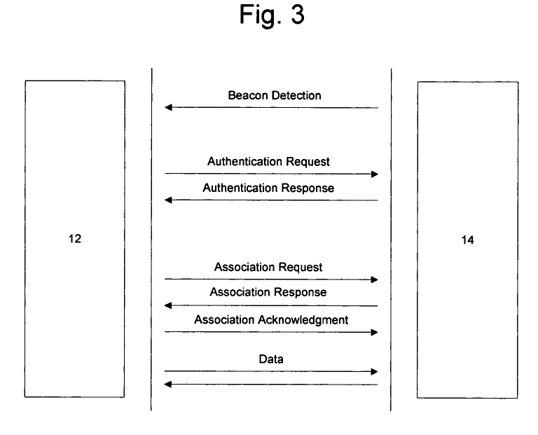

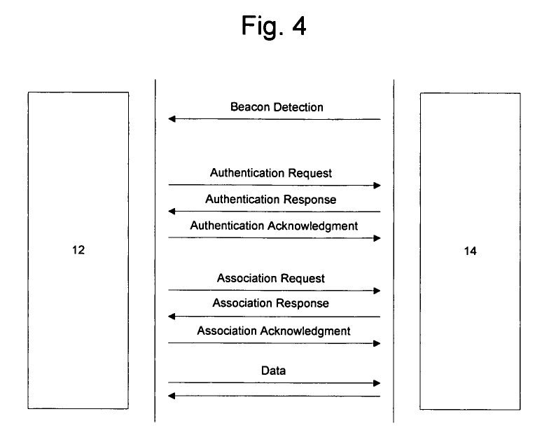

As seen in FIG. 3, In yet another embodiment of the current invention, after the sending of the association response to the other wireless device 14, the method further comprises receiving an association acknowledgment from the other wireless device 14. This variation is similar to standard 802.11 IEEE standard handshake, see FIG. 4, except for the fact that we have eliminated the authentication acknowledgment requirement. By eliminating the authentication acknowledgment requirement the overall time to complete the authentication step is reduced.

An advantage of this invention is that it increases the range in which two wireless devices can establish a link.

Another advantages of this invention is that it increases the probability that a handshake will be completed under weak wireless signal conditions.

Yet a further advantage of this invention is that it reduces the overall time that it takes to complete the authentication step by eliminating the authentication acknowledgment step from the original handshake.

A further advantages of this invention is that it reduces the overall time that it takes to complete the association step by eliminating the association acknowledgment step from the original handshake.

Another advantages of this invention is that it allows users of the 802.11 IEEE standard handshake protocol to connect to a first wireless device using the method of this invention.

Although the present invention has been described in considerable detail with reference to certain preferred versions thereof, other versions are possible. Therefore the spirit and the scope of the claims should not be limited to the description of the preferred versions contained herein.

What is claimed is:

1. A method of enhancing the 802.11 IEEE standard handshake protocol so that the range of connectivity between a first wireless device and other wireless devices can be extended, which comprises the steps of:
Sending from the first wireless device a beacon;
Receiving from any other wireless device a an authentication request;
Sending an authentication response to the other wireless device;
Receiving an association request from the other wireless device; and
Sending an association response to the other wireless device.

2. The Method of claim 1, wherein after the sending the authentication response to the other wireless device, the method further comprises the step of receiving an authentication acknowledgment from the other device.

3. The method of claim 1, wherein after the sending of the association response to the other wireless device, the method further comprises receiving an association acknowledgment from the other wireless device.
